(19) United States
(12) Patent Application Publication
(10) Pub. No.: US 2011/0136692 A1
(43) Pub. Date: Jun. 9, 2011

(54) PROTEIN MICROARRAYS FOR MASS SPECTROMETRY AND METHODS OF USE THEREFOR

(75) Inventors: Robert James Cotter, Baltimore, MD (US); Kenyon Mclane Evans-Nguyen, Baltimore, MD (US); Heng Zhu, Baltimore, MD (US); Sheng-Ce Tao, Baltimore, MD (US)

(73) Assignee: The Johns Hopkins University, Baltimore, MD (US)

(21) Appl. No.: 12/918,399

(22) PCT Filed: Feb. 19, 2009
(86) PCT No.: PCT/US09/34547

§ 371 Date: Feb. 18, 2011

Related U.S. Application Data
(60) Provisional application No. 61/066,282, filed on Feb. 19, 2008.

(51) Int. Cl. C40B 30/10; C40B 40/00; C40B 40/10; C40B 50/14

(52) U.S. Cl. 506/12; 506/13; 506/18; 506/30

(57) ABSTRACT

The present invention relates to the use of mass spectrometry to analyze arrays. The present invention provides methods for characterizing solutions comprising one or more proteins using arrays and mass spectrometry. The arrays of the present invention are coated with porous gold and utilize hydrophobic and hydrophilic self-assembled monolayers.

### CROSS-REFERENCE TO RELATED APPLICATION

This application claims the benefit under 35 U.S.C. §119(e) of U.S. Provisional Application Ser. No. 61/066,282, filed Feb. 19, 2008, which is entirely incorporated herein by reference.

### STATEMENT OF GOVERNMENTAL INTEREST

This invention was made with U.S. government support under grant no. NO1HV28180 and grant no. U5RR020839. The U.S. government has certain rights in the invention.

### FIELD OF THE INVENTION

The present invention relates to the field of arrays. The present invention also relates to the field of mass spectrometry.

### BACKGROUND OF THE INVENTION

Arrays of proteins immobilized on solid substrates have become a powerful tool in biology as a sensitive, high-throughput method that requires little material. Zhu et al., 7 CURR. OPIN. CHEM. BIOL. 55-63 (2003). Protein-protein, protein-lipid, protein-DNA, protein-drug, and protein-peptide interactions have been effectively characterized and kinase substrates have been identified in a high-throughput manner using protein arrays. See, e.g., Zhu et al., 293 SCIENCE 2101-2105 (2001); Hall et al., 306 SCIENCE 482-484 (2004); Huang et al., 101 PROC. NATL. ACAD. SCI. U.S.A. 16594-16599 (2004); Ptacek et al., 438 NATURE 679-684 (2005); and Jones et al., 439 NATURE 168-174 (2006). Through immobilization of antibodies specific to known analytes, arrays have also been used in an analytical capacity. See Haab et al., 2 GENOME BIOL. 1-13 (2001); Joos et al., 21 ELECTROPHORESIS 2461-2650 (2000); and Robinson et al., 8 J. NATL. MED. 295-301 (2002). Protein arrays are typically printed on glass slides functionalized with surface coatings that promote covalent, ionic, or adsorptive immobilization of proteins. Printing is most often performed with contact pin printers or inkjet printers. Thousands of different protein species can be immobilized on a single slide using automated robotics, facilitating high-throughput.

The complexity of solutions that array slides can be probed with is currently limited by detection schemes, most often florescence-based, as well as problems with non-specific absorption/interactions. Although sensitive, fluorescence requires the use of a probe species tagged with a fluorophore or the use of tagged secondary antibodies. Because of this, arrays are usually only probed with simple mixtures containing known species that are specifically labeled. A further complication in probing arrays with complex mixtures is that untagged species could interfere with the binding of the tagged probe species; the data indicate whether or not something has bound to protein spots on the array, but not what has bound. Although complex mixtures have been used with antibody arrays, any cross-reactivity of antibodies or nonspecific binding that occurs goes undetected and can skew results. See Phizicky et al., 422, NATURE 208-21.5 (2008). This is also an issue with many alternative tag-free techniques being developed for protein array interrogation, such as surface plasmon resonance. See, e.g., Lee et al., 78 ANAL. CHEM. 6504-6510 (2006); Nedelkov et al., 79 ANAL. CHEM. 5987-5990 (2007); and Kanoh et al., 78 ANAL. CHEM. 2226-2230 (2006). Protein array experiments relying on detection methods which are blind to chemical identity have to be carefully designed to ensure that the identity of the bound species can be deduced with some certainty.

Mass spectrometry (MS) could be a powerful technique to detect binding at protein arrays immobilized on surfaces. Mass spectrometry can provide molecular information for bound species, which eliminates the need for tags while detecting and potentially characterizing (via tandem mass spectrometry (MS/MS)) unanticipated or unknown binding partners. Additionally, mass spectrometry could detect binding of multiple species from solution to a single spot. For example, the binding of multiple truncated or post-translationally modified versions of a peptide or protein in solution binding to a single immobilized protein can be detected. See Brockman et al., 67 ANAL. CHEM. 4581-4585 (1995). Another powerful application of interrogation of arrays with mass spectrometry is probing arrays with mixtures of small molecules, such as drugs, which are difficult to label efficiently.

The most promising aspect of using mass spectrometry with arrays is the ability to use complex solutions. Ideally, thousands of different proteins printed on a single array could be exposed to numerous untagged probe species in a biological media, such as plasma, and meaningful data about the interactions that occur could be derived. Matrix-assisted laser desorption/ionization time-of-flight mass spectrometry (MALDI-TOF) is one ionization technique that may be used for coupling mass spectrometry and protein arrays because it has been proven effective for molecular imaging applications, primarily tissue imaging, See, e.g., Chaurand et al., 5 J. PROTEOME RES. 2889-2900 (2006); Rubakhin et al., 10 DRUG DISCOVERY TODAY 823-837 (2005); and Schwartz at al., 38 J. MASS SPECTROM. 699-708 (2003). Further, MALDI-TOF is a surface-based technique that has been widely used for analysis of surface-captured analytes and has also been used for high-throughput immunoaffinity mass spectrometry, See Nelson et al., 67 ANAL. CHEM. 1153-1158 (1995); Kiernan et al., 301 ANAL. BIOCHEM. 49-56 (2002); and Kiernan et al., 537 FEBS LETT. 166-170 (2003).

Two major challenges with MALDI-TOF detection of arrays are sensitivity and the required application of organic matrix. Mass spectrometry is less sensitive than fluorescence and is adversely affected by the salts and surfactants often present in biochemical experiments. Furthermore, matrixes in organic solvents spread significantly when deposited on most surfaces, potentially resulting in cross-contamination of spots in an array. A third problem that must be considered with any array that is exposed to complex solutions is non-specific adsorption to the substrate. To effectively couple mass spectrometry to arrays probed with complex solutions, issues of sensitivity, cross-contamination due to matrix addition, and nonspecific adsorption must be overcome.

### SUMMARY OF THE INVENTION

The present invention relates to the fields of arrays and mass spectrometry. Specifically, the present invention provides methods and devices for characterizing and analyzing samples or solutions of known and/or unknown species. In one embodiment, a method for characterizing a solution comprising one or more proteins comprises (a) contacting the solution with a substrate, wherein the substrate comprises (i) a layer of porous gold formed on the substrate, (ii) one or more capture agents attached to at least one hydrophilic material formed on the porous gold, and (iii) at least one hydrophobic material formed on the porous gold; (b) rinsing the substrate; and (c) analyzing the substrate with mass spectrometry. In a specific embodiment, the mass spectrometry may be matrix-assisted laser desportion/ionization-time of flight mass spectrometry (MALDI-TOF MS). Tandem mass spectrometry may also be used.

In another embodiment, the method for characterizing a solution comprising one or more proteins comprises (a) contacting the solution comprising one or more proteins with a substrate, wherein the substrate comprises (i) a layer of porous gold formed on the substrate, (ii) one or more capture agents attached to at least one hydrophilic SAM formed on the porous gold, and (iii) at least one hydrophobic SAM formed on the porous gold; (b) rinsing the substrate; and (c) analyzing the substrate with mass spectrometry.

In yet another embodiment, the method for characterizing a solution comprising one or more proteins comprises (a) contracting the solution comprising one or more proteins with a substrate, wherein the substrate (i) a layer of porous gold formed on the substrate, (ii) one or more capture agents attached to at least one hydrophilic SAM formed on the porous gold, and (iii) at least one hydrophobic SAM formed on the porous gold; (b) rinsing the substrate; and (c) analyzing the substrate with MALDI-TOF MS.

The present invention further provides methods for characterizing a solution comprising one or more species comprising the steps of (a) contacting the solution comprising one or more species with a substrate comprising a layer of porous gold, wherein the one or more species present in the solution binds to one or more capture agents attached to at least one hydrophilic material formed on the porous gold; (b) rinsing the substrate; and (c) analyzing the substrate with MALDI-TOF MS. In a specific embodiment, the substrate further comprises at least one hydrophobic material formed on the porous gold. In addition, the one or more species may be selected from the group consisting of proteins and small molecules.

With regard to the substrate, in several embodiments, the at least one hydrophilic material comprises a self-assembled monolayer (SAM), in a specific embodiment, the SAM comprises a carboxy-terminated SAM. The at least one hydrophobic material of the substrate may comprise a SAM. In a particular embodiment, the SAM comprises a methyl-terminated SAM.

The methods of the present invention may further comprise optionally applying a matrix to the substrate prior to the analyzing step. In certain embodiments, the one or more capture agents is a protein.

As described herein, the present invention also provides substrates useful for characterizing and analyzing samples or solutions of known and/or unknown species. In one embodiment, the substrate comprises (a) a layer of porous gold formed on the substrate; (h) at least one hydrophilic material formed on a portion of the porous gold; (c) one or more capture agents attached to the at least one hydrophilic material; and (d) at least one hydrophobic material formed on a portion of the porous gold. In a specific embodiment, the at least one hydrophilic material comprises a SAM. In particular, the SAM may comprise a carboxy-terminated SAM. In another embodiment, the at least one hydrophobic material comprises a SAM. In a specific embodiment, the SAM comprises a methyl-terminated SAM. In other embodiment, the one or more capture agents is a protein

In an alternative embodiment, the substrate comprises (a) a layer of porous gold formed on the substrate; (b) at least one carboxy-terminated SAM formed on a portion of the porous gold; (c) one or more capture agents attached to the at least one carboxy-terminated SAM; and (d) at least one methyl-terminated SAM formed on a portion of the porous gold.

In yet another embodiment, the present invention provides a method comprising contacting a substrate of the present invention with a solution comprising one or more species; and analyzing the substrate using mass spectrometry. In one embodiment, the mass spectrometry is MALDI-TOF MS. Tandem mass spectrometry may also be used. In addition, the one or more species may be selected from the group consisting of proteins and small molecules.

The present invention further provides methods for preparing a substrate comprising (a) treating a substrate with a gold salt solution; (b) applying a negative potential to the substrate treated with the gold salt solution sufficient to cause a layer of porous gold to be deposited on the substrate; (c) forming at least one hydrophilic SAM on a portion of porous gold; and (d) forming at least one hydrophilic SAM on a portion of the porous gold. The method may further comprise attaching one or more proteins to the at least one hydrophilic SAM formed on a portion of the porous gold. The present invention also provides a substrate produced by such methods. In a specific embodiment, the at least one hydrophilic SAM comprises a carboxy-terminated SAM. In addition, the at least one hydrophobic SAM comprises a methyl-terminated SAM.

The present invention also provides kits useful in characterizing and analyzing samples or solutions of known and/or unknown species. In one embodiment, the kit comprises a first solution comprising at least one hydrophilic SAM to be formed on a portion of porous gold formed on a substrate; and a second solution comprising at least one hydrophobic SAM to be formed on a portion of porous gold formed on the substrate. The kit may further comprise one or more substrates on which porous gold is formed. The kit may also one or more substrates coated with gold. In another embodiment, the kit further comprises a third solution comprising one or more proteins to be attached to the at least one hydrophilic SAM.

### BRIEF DESCRIPTION OF THE FIGURES

FIG. 1 provides a schematic illustration and scanning electron microscope (SEM) images of evaporated gold films (A) without and (B) with porous gold deposited on the surface at (B1) 3500×, (B2) 1000×, and (B3) 10000× magnification and (C) after patterning with mercaptoundecanoic acid (hydrophilic) and dodecanethiol (hydrophobic) SAMs. The white bar in each image represents 10 μm.

FIG. 2 is a schematic illustrating (A) exposure of protein-functionalized porous gold patterns to a complex mixture, (B) species from the solution bound to the immobilized proteins after rinsing, and the subsequent MALDI (C) image and (D) spectra of the bound species. The MS image shown in frame C illustrates three different images, each corresponding to the ink of the molecular ion for the dominant binding peptide, overlaid as the three different colors shown in the legend. The spectra shown in frame D are meant to illustrate the ability of mass spectrometry to recognize multiple species, as shown in the middle spectrum, as well as recognize several variant ligands, as shown in the bottom spectrum, which are simultaneously bound to a single array element.

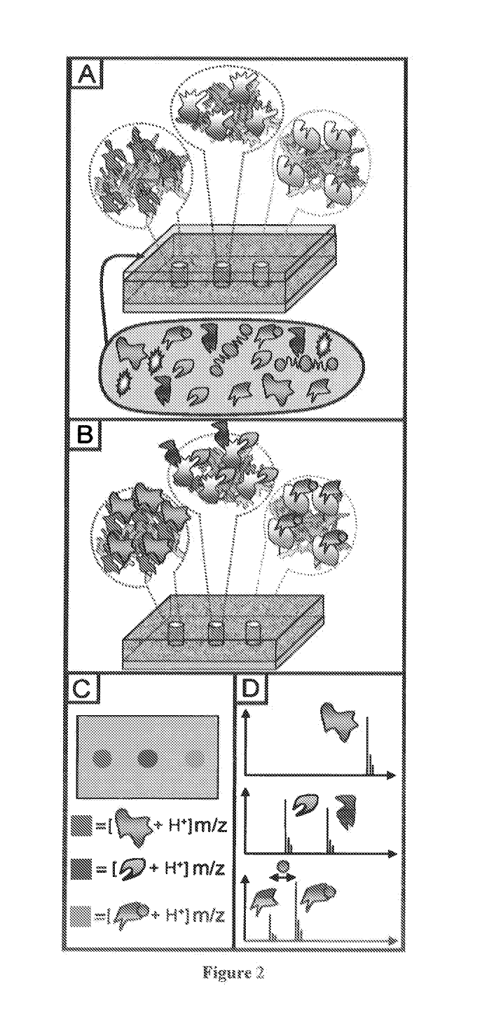

FIG. 3 is a digital photograph of a porous gold surface with a hydrophobic/hydrophilic SAM pattern (A) after brief immersion in and removal from a 1:1 aqueous glycerol solution and (B) while immersed in water, viewed from the front (B1) and side (B2).

FIG. 4 shows a representative reflectron MALDI-TOF (A) MS and (B) MS/MS spectra, annotated with the de novo sequencing of the peptide, of an anti-V5 spot on a porous gold surface probed with 100 nM V5 peptide in water.

FIG. 5 provides the normalized signal for the V5 molecular ion obtained from reflectron spectra of 2000 μm diameter anti-V5 spots from patterned arrays on (left) porous and (right) flat gold probed with (A) 100, (B) 50, (C) 10, (D) 5, and (E) 1 nM V5 peptide solutions in water.

FIG. 6 shows representative MALDI-TOF spectra of individual spots with (A) anti-HA antibody, (B) anti-cmyc antibody, (C) anti-V5 antibody, and (D) control IgG immobilized on the surface after exposure to spiked plasma, rinsing, and matrix addition. The intensities of the spectra are normalized to the intensity of the base peak for each spectra: 294, 137, 483, and 9 mV before for the spectra in A, B, C, and D, respectively. The insets display the isotopic resolution achieved for each major peak.

FIG. 7 demonstrates MS/MS identification of the major peaks observed for individual spots with (A) anti-HA antibody, (B) anti-cmyc antibody, and (C) anti-V5 antibody immobilized on the surface after exposure to spiked plasma, rinsing, and matrix addition.

FIG. 8 shows (A) a digital image of protein solutions incubating on a patterned porous gold surface and the subsequent MALDI-TOF images of (B) a CHCA matrix peak (m/z 378), (C) the HA parent ion (m/z 1102), (D) the cmyc parent ion (m/z 1203), and (E) the V5 parent ion (m/z 1422) after exposure to spiked plasma, rinsing, and matrix addition. The column labels in (A) correspond to the antibody or control immobilized on spots in that column: HA=anti-HA antibody, cmyc=anti-cmyc antibody, V5=anti-V5 antibody, IgG=IgG control. The false color scheme represents peak intensity, where red is the highest intensity in the image, violet is a weak signal, and black is no signal.

FIG. 9 provides overlaid MALDI-TOF images of the surface shown in FIG. 5A after exposure to spiked plasma, rinsing, and matrix addition for the HA parent ion (m/z 1102-green), the cmyc parent ion (m/z 1203-blue), and the V5 peak (m/z 1422-red). The z-axis intensity is in arbitrary units, and the yellow-brown background is set at a threshold of 20 units. The grid in the xy plane indicates the 200 μm² pixels.

FIG. 10 shows (A) a digital image of protein solutions incubating on a patterned porous gold surface and the subsequent MALDI-TOF images of (B) a CHCA matrix parent ion (m/z 378), (C) the HA parent ion (m/z 1102), (D) the cmyc parent ion (m/z 1203), and (E) the V5 parent ion (m/z 1422) after immersion in spiked plasma, rinsing, and matrix addition. The column labels in A correspond to the antibody or control immobilized on spots in that column: HA=anti-HA antibody, cmyc=anti-cmyc antibody, V5=anti-V5 antibody, IgG=IgG control. The false color scheme represents peak intensity, where red is the highest intensity in the image, violet is a weak signal, and black is no signal. The image show in (F) is the overlaid MALDI-TOF images for the HA parent ion (m/z 1102-green), the cmyc parent ion (m/z 1203-blue), and the V5 parent ion (m/z 1422-red). The z-axis intensity is in arbitrary units, and the yellow-brown background is set at a threshold of 20 units. The grid in the xy plane indicates the 200 μm² pixels.

FIG. 11 shows an optical microscope image of a porous gold surface with mercaptoundecanoic acid printed on the surface after immersion in gold etchant solution.

FIG. 12 displays MS/MS spectra for 2000 μm diameter anti-V5 spots from patterned arrays on (red) porous and (black) flat gold probed with (A) 100 nM, (B) 50 nM, (C) 10 nM, and (D) 5 nM V5 peptide solutions in water. The top spectrum shows the entire MS/MS spectrum for the porous gold probed with 100 nM V5, while spectra A-D are expansions of the region outlined in black in the top spectrum. The normalized, expanded spectra in A-D exclude the parent ion to emphasize the signal from the fragment ions used in de novo sequencing.

FIG. 13 shows a patterned porous gold slide (A) after the slide is briefly immersed in 1:1 water:glycerol solution and (B) after overnight incubation in 1 mg/ml BSA solution. Note that the pattern is largely unaffected.

FIG. 14 displays a fluorescence image of the 9 mm spread of 0.3 μL, of CHCA matrix solution deposited on a glass slide.

FIG. 15 provides an illustration of the binding of the highly glycosylated protein horseradish perixodase (HRP) to an array with immobilized lectin Concanavalin A (Con A), which binds HRP, and in-situ digestion with trypsin followed by MS spectrum of the trypsinized fragments.

FIG. 16 shows an illustration of the experiment shown in FIG. 15 and a control in which a “blank” lectin Con A array is subjected to in situ digestion with trypsin.

FIG. 17 displays the results of a Mascot search of the Con A array probed with HRP.

FIG. 18 displays the peptide matches from a Mascot search of the Con A array probed with HRP, with ConA results subtracted.

### DETAILED DESCRIPTION OF THE INVENTION

It is understood that the present invention is not limited to the particular methods and components, etc., described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to a “protein” is a reference to one or more proteins, and includes equivalents thereof known to those skilled in the art and so forth.

Unless defined otherwise, all technical and scientific terms used herein have the same meaning as commonly understood by one of ordinary skill in the art to which this invention belongs. Specific methods, devices, and materials are described, although any methods and materials similar or equivalent to those described herein can be used in the practice or testing of the present invention.

All publications cited herein are hereby incorporated by reference including all journal articles, books, manuals, published patent applications, and issued patents. In addition, the meaning of certain terms and phrases employed in the specification, examples, and appended claims are provided. The definitions are not meant to be limiting in nature and serve to provide a clearer understanding of certain aspects of the present invention.

### Arrays.

The present invention provides an array useful in studying, characterizing, and analyzing the interactions between and among proteins, lipids, DNA, drugs, and peptides. An array may comprise a substrate or support to which a number of compounds may be attached. The term “substrate” refers to a material having a rigid or semi-rigid surface. By rigid, the substrate is solid and preferably does not readily bend. As such, the rigid or semi-rigid substrates are sufficient to provide physical support and structure to the compounds present thereon under the conditions in which the array is utilized, particularly under high-throughput handling conditions.

In some embodiments, at least one surface of the substrate will be substantially flat. In other embodiments, a roughly spherical shape may be preferred. The arrays of the present invention need not necessarily be flat nor entirely two-dimensional. Indeed, significant topological features may be present on the surface of the substrate. For example, walls or other barriers may separate the regions of the array.

The substrate may be either organic or inorganic, biological or non-biological, or any combination of these materials. In addition, the substrate may be transparent or translucent. Numerous materials are suitable for use as a substrate for an array of the present invention. The substrate may comprise a material selected from the group consisting of silicon, silica, quartz, glass, controlled pore glass, carbon, alumina, titania, tantalum oxide, germanium, silicon nitride, zeolites, and gallium arsenide. Many metals such as gold, platinum, aluminum, copper, titanium, and their alloys may be useful as substrates of the array. Alternatively, many ceramics and polymers may also be used as substrates. Polymers that may be used as substrates include, but are not limited to polystyrene; poly(tetra)fluoroethylene (PTFE); polyvinylidenedifluoride; polycarbonate; polymethylmethacrylate; polyvinylethylene; polyethyleneimine; poly(etherether)ketone; polyoxymethylene (POM); polyvinylphenol; polylactides; polymethacrylimide (PMI); polyalkenesulfone (PAS); polypropylethylene, polyethylene; polyhydroxyethylmethacrylate (HEMA); polydimethylsiloxane; polyacrylamide; polyimide; and block-copolymers. The substrate may also be a combination of any of the aforementioned materials.

Such materials may take the form of plates or slides, small beads, pellets, disks or other convenient forms, although other forms may be used. In a specific embodiment, substrate is a glass microscope slide.

In other embodiments, the substrate may include a coating. The coating may be formed on, or applied to, the substrate surface. The substrate may be modified with a coating by using thin-film technology based, for example, on physical vapor deposition (PVD), plasma-enhanced chemical vapor deposition (PECVD), or thermal processing. Alternatively, plasma exposure may be used to directly activate or alter the substrate and create a coating. For example, plasma etch procedures can be used to oxidize a polymeric surface (for example, polystyrene or polyethylene to expose polar functionalities such as hydroxyls, carboxylic acids, aldehydes and the like) which then acts as a coating.

Furthermore, the coating may comprise a solid or porous metal film. The metal film may range from about 50 nm to about 500 nm in thickness. Alternatively, the metal film may range from about 1 nm to about 1 μm in thickness. Examples of metal films that may be used as substrate coatings include aluminum, chromium, titanium, tantalum, nickel, stainless steel, zinc, lead, iron, copper, magnesium, manganese, cadmium, tungsten, cobalt, and alloys or oxides thereof. In one embodiment, the metal film is a noble metal film. Noble metals that may be used for a coating include, but are not limited to, gold, platinum, silver, and copper. In another embodiment, the coating comprises gold or a gold alloy. Electron-beam evaporation may be used to provide a thin coating of gold on the surface of the substrate. Additionally, commercial metal-like substances may be employed such as TALON metal affinity resin and the like.

In alternative embodiments, the coating may comprise a composition selected from the group consisting of silicon, silicon oxide, titania, tantalum oxide, silicon nitride, silicon hydride, indium tin oxide, magnesium oxide, alumina, glass, hydroxylated surfaces, and polymers.

Several different types of coating may be combined on the substrate surface. The coating may cover the whole surface of the substrate or only parts of it. In one embodiment, the coating covers the substrate surface only at the site of the regions of capture agents. Techniques useful for the formation of coated regions on the surface of the substrate are well known to those of ordinary skill in the art. For example, the regions of coatings on the substrate may be fabricated by photolithography, micro-molding (WO 96/29629), wet chemical or dry etching, or any combination of these.

The substrates of the present invention may also be referred to herein an “array” or even a “microarray,” although the substrates and arrays of the present invention are not limited to any particular size or patterns of materials formed thereon.

Moreover, a layer of material may be formed on the substrate. As used herein, the term “porous” refers to a material having an increased surface area relative to a flat or planar material. The porous material may comprise a network having a plurality of pores, openings, surfaces, and/or channels of various geometries and dimensions. The material may be nanoporous or microporous, i.e., the average size of the pores, openings, surfaces, and/or channels may suitably be comprised between about 0.001 μm and about 100.0 μm, between about 0.01 μm and about 10.0 μm, between about 0.1 μm and about 1.0 μm, or between about 0.3 μm and about 0.6 μm. The pore size distribution may or may not be substantially uniform. In the present invention, a porous material may be formed on a substrate. Alternatively, the substrate may itself be a porous material or the substrate may be treated to make it porous. In another embodiment, a material may be formed on a substrate in such a manner to form a porous layer of material on the substrate. A non-limiting example of a material that may be used to create porous layer on a substrate is gold.

### Self-Assembled Monolayers.

An array of the present invention may be prepared by attaching a self-assembled monolayer to the surface of a substrate. A “self-assembled monolayer” or “SAM” refers to a relatively ordered assembly of molecules chemisorbed on a surface, in which the molecules are oriented approximately parallel to each other and roughly perpendicular to the surface. The SAM may be formed or attached to the substrate directly (i.e., a bond connects the SAM and the substrate) or indirectly (i.e., SAM is bound to another material, which in turn is bound to the substrate). Examples of compounds that can be used to form a SAM including, but are not limited to, n-alkanoic acid (CₙH₂ₙ+1COOH); alkyl silanes such as alkylchlorosilanes, alkylalkoxysilanes and alkylaminosilanes; and organosulfur compounds such as alkylthiolates, n-alkyl sulfide, di-n-alkyl disulfide, thiophenols, mercaptopyridines, mercaptoanilines and mercaptoimidazoles. For information on methods used to form SAMs, see generally U.S. Pat. No. 5,620,850; Laibinis et al., 245 SCIENCE 845 (1989); Bain et al., 111 J. AM. CHEM. SOC. 7155-7164 (1989); and Bain et al., 111 J. AM. CHEM. SOC. 7164-7175 (1989).

Generally, the compounds forming the self-assembled monolayers consist of a reactive group in the head portion, which binds to the substrate, a long alkane chain in the body portion, which allows the formation of regular molecular layers, and a functional group in the terminal portion, which determines the function of the molecular layers. In a non-limiting example, the functional group in the terminal portion can be exemplified by an alkyl group as the simplest functional group and can be one or a mixture of two or more selected from among amine, thiol, carboxy, methyl, aldehyde, epoxy and maleimide.

Accordingly, SAMs may be produced with varying characteristics and with various functional groups at the free end of the molecules which form the SAM (direction away from the surface to which the SAM attaches). For example, SAMs may be formed which are generally hydrophobic or hydrophilic, generally cytophohic or cytophilic, or generally biophohic or biophilic. Additionally, SAMs with these or other characteristics can be formed and then modified to expose different functionalities. SAMs with very specific binding affinities can be produced in certain instances, which allows for the production of patterned SAMs which will bind one or more biomolecules on the surface in specific and predetermined patterns. See, e.g., U.S. Pat. No. 5,776,748.

In certain embodiments the SAMs may be arranged on the surface of an array in discrete spots. For example, as described in the Examples section below, a series of SAMs maybe formed on the surface of a substrate using a hydrophilic compound such as mercaptoundecanoic acid. Such hydrophilic SAMs may be applied manually using a pipet or in an automated fashion using equipment commonly used to print arrays including pin printers and inkjet printers. In addition, a region of hydrophilic SAMs maybe applied to the same substrate, for example, by immersing the substrate (following printing of hydrophilic SAM spots) in a solution of ethanolic dodecanethiol, as described below. In a specific embodiment, an array is prepared with a pattern of hydrophilic regions spotted on a substrate. The hydrophilic regions or spots may comprise a SAM. In a particular embodiment, the hydrophilic SAM may be a carboxy-terminated SAM. In addition, a hydrophobic region may be deposited on the substrate. In one embodiment, the hydrophobic region may comprise a SAM, including a methyl-terminated SAM.

The use of these hydrophilic/hydrophobic pattern on array provides several advantages. The porous gold provides a larger surface area than previous methods. Thus, more SAMs may be used to generate hydrophilic spots and “superhydrophobic” regions. The use of porous gold and these hydrophilic/superhydrophobic regions results in robust patterns that can be exposed to complex biological solutions such as blood or plasma, and still maintain their integrity. In addition, the use of matrices in MALDI MS is problematic when detecting species bound at protein arrays. The matrices are dissolved in organic solvents that spread significantly when deposited on most surfaces, potentially resulting in cross-contamination of spots on the array. The use of the robust hydrophilic/superhydrophobic patterns of the present invention contains the matrix solution within the hydrophilic spot and prevents cross-contamination.

A further advantage of the hydrophilic/hydrophobic SAMs is that the proteins can be digested directly on spots without resulting in cross-contamination of digested peptides between spots. Trypsin solution can be conveniently applied to the superhydrophobic/hydrophilic pattern. Because of this pattern, the trypsin solution is retained in the hydrophilic spot. Peptide cleavage products are confined to each individual spot on the array. By preventing digested peptides in adjacent spot from mixing, the present invention facilitates the identification of unknown proteins bound to the array.

### Immobilization of Capture Agents to the Array and Related Uses Thereof.

The arrays of the present invention may have one or more capture agents bound thereto. The arrays with the bound capture agents may further be used to test a sample of known and/or unknown species as described below and known to those of ordinary skill in the art. Capture agents such as proteins and/or small molecules may be bound to the substrate array through any suitable technique. For example, the capture agent may be bound to the substrate directly (i.e., a bond connects the capture agent and the substrate) or indirectly (i.e., the capture agent is bound to a SAM, which in turn is bound to the substrate). A bond may be a chemical or a physical bond. Examples of bonds include, but are not limited to, a covalent bond, an ionic bond, a hydrogen bond, a van der Waals bond, a metal ligand bond, a dative bond, a coordinated bond, a hydrophobic interaction, or the like.

Examples of methods of coupling the capture agent to the substrate (directly or indirectly, through a SAM, for example) include reactions that form linkages such as thioether bonds, disulfide bonds, amide bonds, carbamate bonds, urea linkages, ester bonds, carbonate bonds, ether bonds, hydrazone linkages, Schiff-base linkages, and noncovalent linkages mediated by, for example, ionic or hydrophobic interactions. The form of reaction will depend, of course, upon the available reactive groups on both the substrate/SAM and the capture agent.

Moreover, the capture agents may be discretely arranged on the surface of the substrate, for example, forming a series of regions or “spots.” The spots may have any shape, for example, circular, oval, rectangular, square, arbitrary shapes, etc., and the arrangement of spots on the surface may be regular or irregular. The spots may each independently contain the same or different capture agents, for example, one or more proteins, small molecules, other entities, etc. For example, capture agents may be bound to hydrophilic SAMs spotted on a substrate. The substrate may further comprise a hydrophobic region of SAMs.

In particular embodiments of the present invention, the capture agent bound to the array is a protein. A “protein” means a polymer of amino acid residues linked together by peptide bonds. As used herein, the term refers to proteins, polypeptides, and peptides of any size, structure, or function. A protein may be naturally occurring, recombinant, or synthetic, or any combination of these. A protein may also comprise a fragment of a naturally occurring protein or peptide. In some instances, the protein may include other entities besides amino acids, for example, carbohydrates or phosphate groups. The term protein may also apply to amino acid polymers in which one or more amino acid residues is an artificial chemical analogue of a corresponding naturally occurring amino acid.

In a specific embodiment, the protein capture agent may be an antibody. As used herein, the term “antibody” means an immunoglobulin, whether natural or partially or wholly synthetically produced. All derivatives thereof that maintain specific binding ability are also included in the term. The term also covers any protein having a binding domain that is homologous or largely homologous to an immunoglobulin binding domain. An antibody may be monoclonal or polyclonal. In addition, the antibody may be a member of any immunoglobulin class, including any of the human classes: IgG, IgM, IgA, IgD, and IgE.

In another embodiment of the present invention, the capture agent may be a small molecule. A “small molecule,” as used herein, means a molecule having a molecular weight of less than 5 kilodaltons (kDa), and more typically less than 1 kDa. In some embodiments, the small molecule may be a protein or a peptide sequence. In other embodiments, the small molecule may be a member of any of a wide variety of organics; as non-limiting examples, the small molecule may be one or more of a carbohydrate, a sugar, a drug, an alcohol, a carboxylic acid, an amine, an aldehyde or a ketone, a thiol, a cyclic or an acyclic compound, etc.

The capture agents may further include naturally-occurring molecules or molecule fragments such as nucleic acids, nucleic acid analogs (e.g., peptide nucleic acid), polysaccharides, phospholipids, capture proteins including glycoproteins, peptides, enzymes, cellular receptors, immunoglobulins, antigens, naturally occurring ligands, polymers, and antibodies (including antibody fragments) such as antigen-binding fragments (Fabs), Fab′ fragments, pepsin fragments (F(ab′)₂ fragments), scFv, Fv fragments, single-domain antibodies, dsFvs, Fd fragments, and diabodies, full-length polyclonal or monoclonal antibodies, and antibody-like fragments, such as modified fibronectin, CTL-A4, and T cell receptors.

Thus, capture agents may comprise one of a pair of binding molecules. The term “binding” refers to the interaction between a corresponding pair of molecules or surfaces that exhibit mutual affinity or binding capacity, typically due to specific or non-specific binding or interaction, including, but not limited to, biochemical, physiological, and/or chemical interactions. “Biological binding” defines a type of interaction that occurs between pairs of molecules including proteins, nucleic acids, glycoproteins, carbohydrates, hormones and the like. Specific non-limiting examples include antibody/antigen, antibody/hapten, enzyme/substrate, enzyme/inhibitor, enzyme/cofactor, binding protein/substrate, carrier protein/substrate, lectin/carbohydrate, receptor/hormone, receptor/effector, complementary strands of nucleic acid, protein/nucleic acid repressor/inducer, ligand/cell surface receptor, virus/cell surface receptor, etc.

In certain embodiments, a capture agent may be tagged in some fashion, for example, with fluorescent, chemiluminescent, radioactive, chromatic and other physical or chemical labels or epitopes. In other embodiments of the present invention, the capture agent may be unlabeled, and detection may occur through the use of mass spectroscopy.

The arrays of the present invention may be used to characterize a solution or sample of known and/or unknown species including proteins, peptides, small molecules, inhibitors, activators, etc. The test solution or sample may comprise a simple mixture, for example, containing known species that are specifically labeled. In alternative embodiments, the present invention may be used to characterize or analyze more complex solutions or samples. For example, a biological or patient sample may be used with the arrays and mass spectrometry analyses of the present invention. Biological samples may be isolated from several sources including, but not limited to, a patient or a cell line. Patient samples may include blood, urine, amniotic fluid, plasma, semen, bone marrow, and tissues.

### Mass Spectrometry.

The present invention further relates to the use of mass spectrometry to analyze the results of array assays and experiments. Mass spectrometers are instruments that are used to determine the chemical composition of substances and the structures of molecules. In general, mass spectrometers consist of an ion source where neutral molecules are ionized, a mass analyzer where ions are separated according to their mass/charge ratio, and a detector. Mass analyzers come in a variety of types and are commercially available, including magnetic field (B) instruments, combined electric and magnetic field or double-focusing instruments (EB or BE), quadrupole electric field (Q) instruments, and time-of-flight (TOF) instruments. In addition, two or more analyzers may be combined in a single instrument to produce tandem (MS/MS) mass spectrometers. These include triple analyzers (EBE), four sector mass spectrometers (EBEB or BEEB), triple quadrupoles (QqQ) and hybrids (such as the EBqQ). For further information on mass spectrometers, see U.S. Pat. No. 7,372,021; U.S. Pat. No. 7,271,397; U.S. Pat. No. 7,045,777; U.S. Pat. No. 7,015,463; U.S. Pat. No. 6,365,892; U.S. Pat. No. 5,814,813; U.S. Pat. No. 5,696,376; U.S. Pat. No. 5,572,025; U.S. Pat. No. 5,464,985; U.S. Pat. No. 5,399,857; U.S. Pat. No. 5,202,563; U.S. Pat. No. 5,101,105; and U.S. Pat. No. 4,603,222.

One type of mass spectrometer that may be used in the present invention is a time-of-flight (TOF) mass spectrometers. See, e.g., Cotter, Robert J., Time-of-Flight Mass Spectrometry: Instrumentation and Applications in Biological Research, American Chemical Society, Washington, D.C., 1997, the entire contents of which is hereby incorporated by reference. The spectrometer consists of a short source region, a longer field-fee drift region, and a detector. See, U.S. Pat. No. 7,381,945.

In certain embodiments, the arrays of the present invention may be analyzed using an ionization technique for mass spectrometers known as matrix-assisted laser desorption ionization (MALDI). In a particular embodiment, the arrays are analyzed using MALDI in conjunction with TOF MS (MALDI-TOF). MALDI is particularly effective in ionizing large molecules (e.g. peptides and proteins, carbohydrates, glycolipids, glycoproteins, and oligonucleotides (DNA)) as well as other polymers. The TOF mass spectrometer provides an advantage for MALDI analysis by simultaneously recording ions over a broad mass range, which is the so called multichannel advantage. In the MALDI method of ionization, biomolecules to be analyzed are re-crystallized in a solid matrix (e.g., sinnipinic acid, 3-hydroxy picolinic acid, etc.) of a low mass chromophore that is strongly absorbing in the wavelength region of the pulsed laser used to initiate ionization. Following absorption of the laser radiation by the matrix, ionization of the analyte molecules occurs as a result of desorption and subsequent charge exchange processes. In TOF instruments, all ion optical elements and the detector are enclosed within a vacuum chamber to ensure that ions, once formed, reach the detector without collisions with the background gas.

Without further elaboration, is believed that one skilled in the art, using the proceeding description, can utilize the present invention to the fullest extent. The following example are illustrative only, and not limiting of the remainder of the disclosure in any way whatsoever.

### EXAMPLES

### Materials and Methods

Materials. Gold-coated microscope slides (50 nm Cr adhesion layer, 100 nm gold) were purchased from EMF Corp. (Ithaca, N.Y.) and used as the gold substrates in all experiments. Hydrogen tetrachloroaurate(III) was purchased from Acros Organics (Geel, Belgium). Mercaptoundecanoic acid and dodecanethiol were obtained from Sigma (St. Louis, Mo.). 1-Ethyl-3-[3-dimethylaminopropyl] carbodiimide hydrochloride (EDC) and N-hydroxy-succinimide (NHS) were purchased from Pierce Biotechnology (Rockford, Ill.). Affinity peptides (HA, V5, and cmyc) were acquired from Anaspec (San Jose, Calif.), and the corresponding goat polyclonal antibodies were obtained from QED Biosciences (San Diego, Calif.); the goat IgG used for controls was purchased from Sigma, α-Cyano-4-hydroxycinnamic acid (CHCA) was used as the MALDI matrix for all experiments and was obtained from Sigma. HPLC grade water was used for all solutions as well as for washing and rinsing steps.

Bovine plasma was obtained from bovine whole blood purchased from Ruppersberger slaughterhouse (Baltimore, Md.). Whole blood was collected from a single cow into a container with 4 mg/ml EDTA as anticoagulant. The blood was centrifuged at low speeds to remove the cells without rupturing them. The supernatant was collected and centrifuged again at moderate speeds to deplete the platelets without rupturing them. The platelet-poor plasma supernatant was collected and used for all plasma experiments.

Porous Gold Deposition. First, gold substrates were cleaned in piranha solution (3:1 H₂SO₄, 30% H₂O₂) for approximately 30 min. After rinsing thoroughly with water and ethanol, the slides were blown off under a stream of nitrogen, mounted in a Teflon deposition cell, and immersed in a 3 mg/ml hydrogen tetrachloroaurate solution in 0.5 M H₂SO₄. Under constant stirring conditions, a potential of −400 mV versus a Ag/AgCl reference electrode was applied, using a Pt mesh counter electrode with a solution-exposed surface area larger than that of the gold-coated microscope slide. The potentiostat circuit used was constructed based on a previously published design (Kirkup et al., 63 REV. SCI. INSTRUM. 2328-2329 (1992)) and could sustain currents up to approximately 200 mA. The deposition was stopped when 175 C of charge had accumulated. To conserve gold, the gold solutions were reused for multiple porous gold depositions. This resulted in a gradual depletion of gold salts from solution and a decrease in steady-state current after multiple depositions. Therefore, the stopping point for porous gold deposition was based on a fixed charge rather than a fixed time. After the deposition, the substrates were removed from the cell and re-cleaned with piranha solution as described above. After cleaning, the substrates were rinsed thoroughly, blown off under a nitrogen stream, and stored dry.

Patterning of Self-Assembled Monolayers. Patterns of SAMs were generated using a microarray pin printer (VersArray Chip Writer; Hercules, Calif.), a chemical inkjet printer (CHIP 1000, Shimadzu Biotech; Columbia, Md.), or an Epson Stylus Photo R220 (Epson America, Inc.; Long Beach, Calif.). For printing with the Epson printer, the CD-printing tray was fitted with a mask to hold a microscope slide and a roller was removed to avoid roller contact with the surface. Empty ink cartridges were purchased from CompuBiz Inkjet (Wheatland, Wyo.) and were filled with appropriate thiol solutions.

For initial experiments testing the signal as a function of peptide concentration, slides were printed using the Epson inkjet. An array consisting of five columns and three rows of carboxy-terminated SAM spots 2000 μm in diameter was printed from ˜2 mM solutions of mercaptoundecanoic acid. For experiments testing antibody arrays in bovine plasma, a pattern of three arrays was printed. Each array consisted of four columns and three rows and contained either large, medium, or small spot sizes. To verify the integrity of the printed carboxy-terminated SAM spots, a patterned test slide was immersed in a mild gold etchant solution (Bietsch, et al., 20 LANGMUIR 5119-5122 (2004)) until all the unprotected gold regions were removed. To create a methyl-terminated SAM background, the remaining slides were immersed in ˜2 mM solutions of ethanolic dodecanethiol for approximately 10 s. Once the slides were removed, they were rinsed thoroughly with ethanol and water and then blown dry under a stream of nitrogen. The successful formation of the hydrophobic/hydrophilic pattern was monitored by immersion of the slides in solutions of ultrapure water. For acquiring camera and microscope images of hydrophobic/hydrophilic patterns, the slides were immersed into a 1:1 glycerol/water solution to prevent rapid evaporation from smaller spots.

Protein Immobilization and Peptide Capture Experiments. The carboxy groups on the hydrophilic SAM spots were activated for covalent protein immobilization by immersion in a freshly made solution of 4 mM EDC/10 mM NHS for 1 h. See Fung et al., 73 ANAL. CHEM. 5302-5309 (2001); and Labiri, et al., 71 ANAL. CHEM. 777-790 (1999). Antibody and control IgG or BSA solutions were then manually spotted onto the NHS ester functionalized hydrophilic spots using a microliter pipet. The slides were incubated for 2 h in a humidity chamber and then rinsed thoroughly with water. Once the slides were functionalized with the proteins, they were not allowed to dry at any point until just before CHCA matrix was added. In initial experiments, anti-V5-functionalized surfaces were exposed to varying concentrations of the V5 peptide antigen in purified water. In experiments testing the multiple-antibody arrays, the slides were exposed to bovine plasma spiked to a concentration of 2 μM with HA, cmyc, and V5 peptides. The spiked plasma was either directly added as droplets to the hydrophilic spots with a pipet or the slide was briefly immersed in the spiked plasma. To avoid drying of the liquid retained on the hydrophilic spots, the slides were quickly placed into a humidity chamber and incubated for an hour. The slides were then rinsed with water, immersed in water three times for 10 min. each time, rinsed again with water, and blown off under a stream of nitrogen. Once the spots were dry, 0.2 μL of either 5, 1, or 0.5 mg/ml of CHCA matrix in 70% acetonitrile, 30% trifluoroacetic acid (0.1%) was applied to the large, medium, or small spot size arrays, respectively.

Mass Spectrometry. All MS and MS/MS spectra were acquired in the positive ion mode at an acceleration voltage of 20 kV using a Kratos Analytical (Manchester, U.K.) AXIMA-CFR Plus MALDI-TOF high-performance mass spectrometer capable of acquiring linear or reflectron spectra. External calibration was performed using a mixture of three calibrant peptides spotted in the center of each Slide in a region that did not contain any arrayed spots. The peptides used in the binding experiments (HA, cmyc, V5) were never used as calibrant peptides. MS/MS spectra were collected without collision gas. MS images were acquired by dividing the imaged area into pixels of 200 μm×200 μm. At each pixel, 20 spectra were acquired, averaged, and converted to ASCII files. The ASCII files were sorted and compiled into images using a Lab VIEW program and MathCAD. The images are comprised of the signal intensities represented in false color, sorted spatially based on the pixel position, and were generated from spectra in two ways. The signal intensity for each m/z window of ±7 was determined at each pixel by either summing all of the signal in the window or the window was searched for the point of maximum signal, and this was assigned as the pixel intensity.

Kits. The present invention further provides kits useful for characterizing and analyzing samples or solutions of known and/or unknown species. In one embodiment, the kit comprises a first solution comprising hydrophilic SAMs to be spotted on a substrate coated with porous gold; and a second solution comprising hydrophobic SAMs to be deposited on the substrate. The kit may further comprise one or more substrates coated with porous gold. The kit may also one or more substrates coated with gold. In another embodiment, the kit further comprises a third solution comprising one or more proteins to be immobilized to the hydrophilic SAMs.

### Example 1

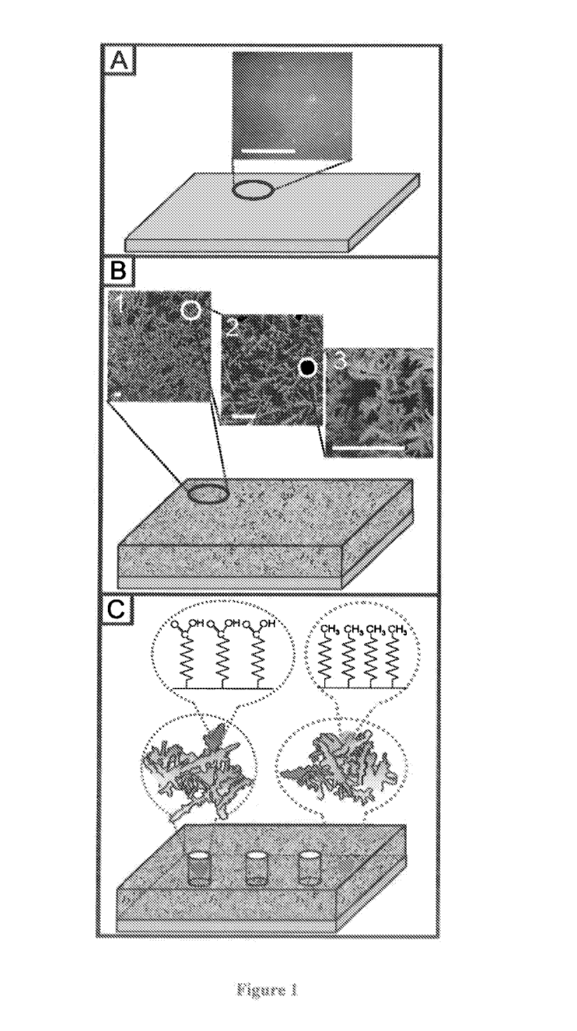

Preparation of Patterned Gold Surfaces. Although the charge obtained from integration of the current was used as a qualitative indicator of the thickness of the deposited porous gold layer, these values were not used to rigorously calculate thickness. Due to reaction conditions, it is likely that there were minor contributions to the current from side reactions, such as hydrogen gas evolution in solution and reduction at small solution-exposed portions of the Pt wire making the electrical connection with a gold surface. The color of the gold-coated substrates was visibly altered after the porous gold was deposited, turning from bright yellow to tan. SEM images acquired after porous gold deposition show the nanostructured porous gold with significantly enhanced surface area (FIG. 1).

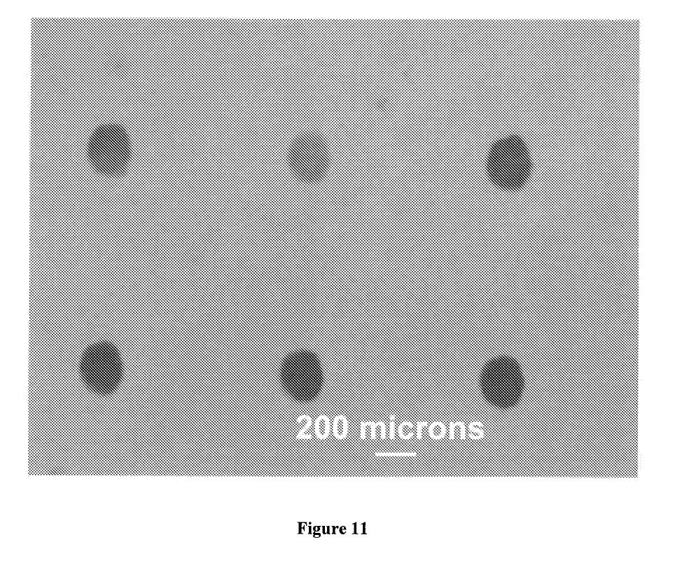

Self-assembled monolayers formed rapidly when either the pin printer or the chemical inkjet printer were used to deposit mercaptoundecanoic acid solutions onto the porous gold substrates. Self-assembled monolayer formation in the mercaptoundecanoic acid-printed regions was tested by immersion of a test slide in a gold etchant solution. While the underlying gold in the printed regions was protected, gold in the unprinted regions dissolved in the etchant solution (FIG. 11). See also Bietsch, et al., 20 LANGMUIR 5119-5122 (2004).

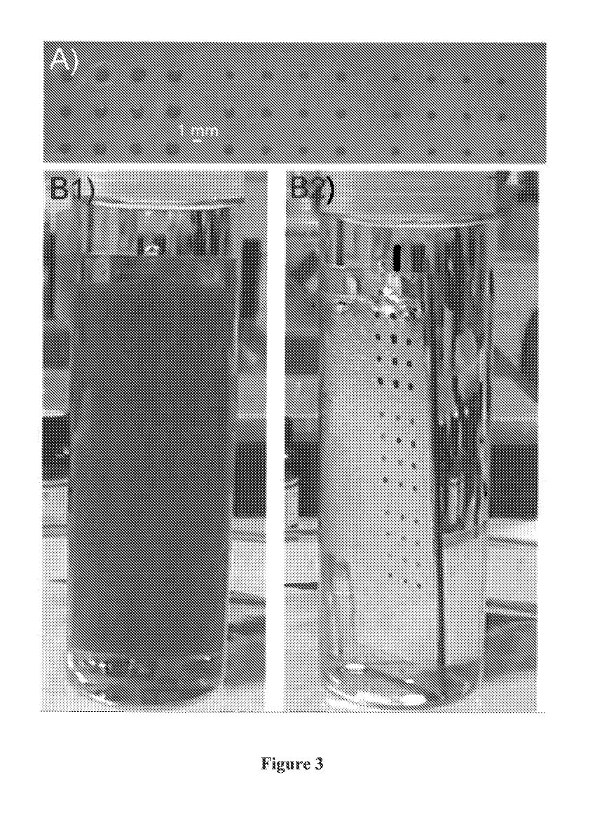

Immersion of mercaptoundecanoic acid-printed surfaces in dodecanethiol solution resulted in hydrophobic SAM formation in the unprinted, bare gold regions. These hydrophobic/hydrophilic patterns were readily apparent when the slides were immersed in aqueous solution (FIG. 3). Spot sizes were dependent on the volume of mercaptoundecanoic acid deposited on the surface for both the pin-printed, where the volume is determined by the number of times the pin contacted the surface, and inkjet-printed surfaces. Numerous patterns with different layouts and spot sizes were easily printed using the Epson inkjet printer, the Shimadzu CHIP inkjet printer, and the pin printer. Additionally, patterns could be created manually by carefully spotting mercaptoundecanoic acid solution with a microliter pipet. The porous gold substrates could be reused, even after exposure to bovine plasma and matrix, by cleaning the surfaces with piranha solution twice. Porous gold surfaces have been reused numerous times (>10) and no detrimental affects have been observed on the SAM patterns produced or the mass spectrometry signal for the antibody array assay. Porous gold layers are easily scratched, however, through contact with the surface, and scratches can significantly affect the patterns produced.

### Example 2

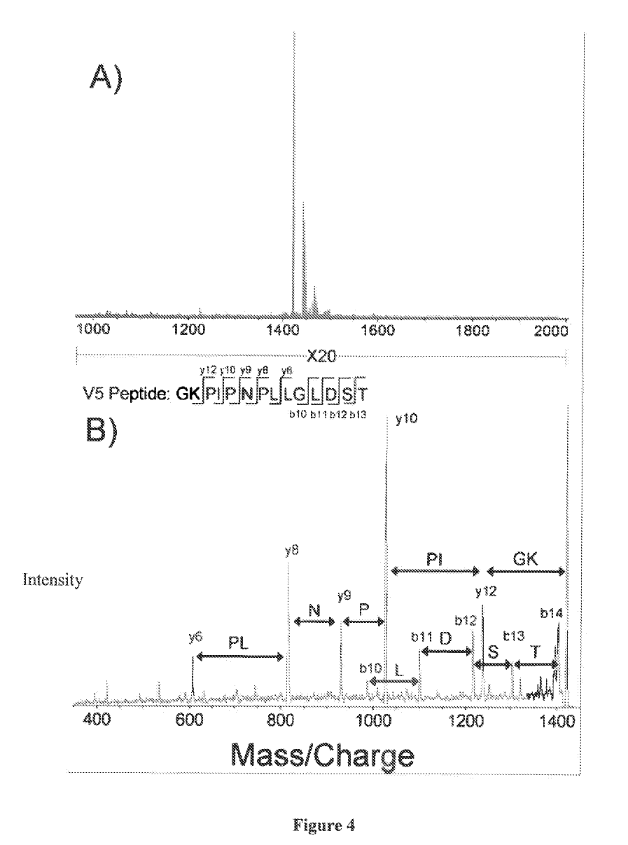

Comparison of MS and MS/MS Signals from Porous and Flat Gold Surfaces. When spots on porous gold were functionalized with anti-V5, exposed to V5 solution, rinsed, and exposed to matrix solution, reflectron MALDI-TOF spectra were obtained where the m/z of the base peak correlated with the [M+H]⁺ ion for V5 (FIG. 4). Further, the bound V5 was de novo sequenced using the MS/MS spectra. Control spots functionalized with BSA yielded no significant peaks. The surface roughness does not appear to adversely affect the mass spectrometry, and the conductivity of the substrate likely yields improved signal relative to glass slides, since previous studies of mass spectrometry on glass-based affinity slides have noted reduced signal as well as reduced fragmentation in MS/MS spectra relative to metallic substrates. See Afonso et al., 75 ANAL. CHEM. 694-697 (2003). The mass accuracy in these experiments was slightly lower than in standard MALDI-TOF experiments conducted using a finely machined stainless steel plate with the same instrumentation. This may be attributes to the way that the slides were mounted on the stainless steel plate, in depressions machined to match the height of the slides and secured with double-sided tape. This arrangement is not ideal because there the slide is not precisely level, resulting in minor drift from the initial m/z calibration across the length of the slide. These MS and MS/MS spectra for the individual spots demonstrate that patterned porous gold is an effective substrate for immunoaffinity MS experiments.

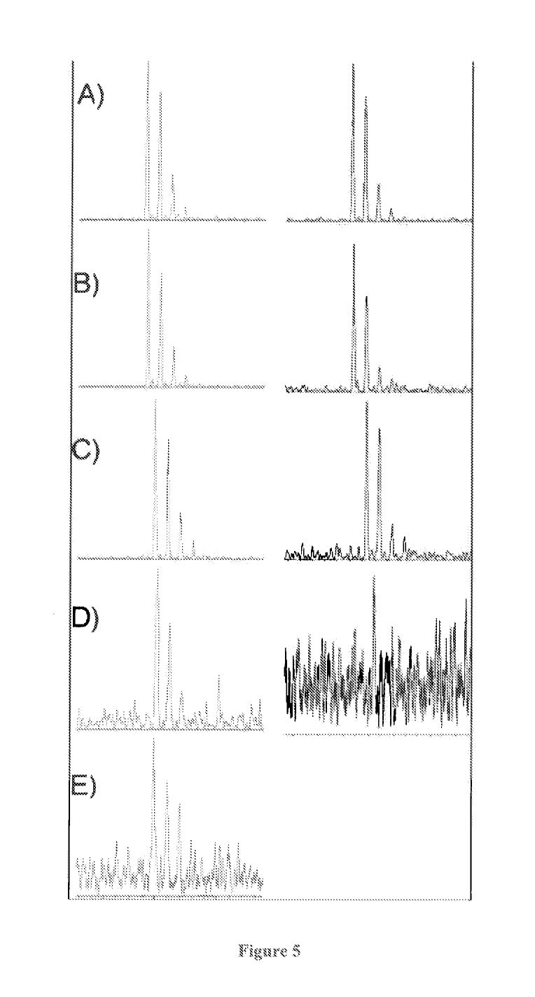

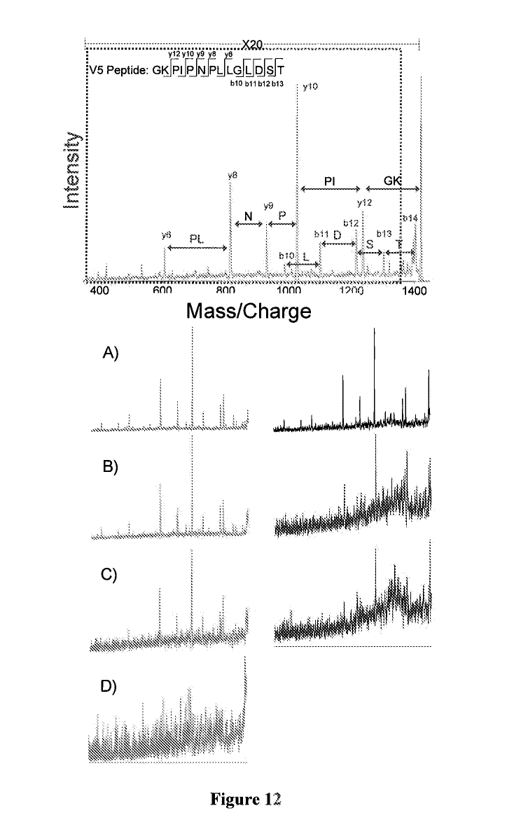

To study the signal enhancement imparted by deposition of porous gold, five columns on an array of anti-V5 antibody were probed with 10 μL droplets of varying concentrations of V5. The V5 [M+H]⁺ peak for arrays on both porous gold and flat gold probed with 100, 50, 10, 5, and 1 mM V5 are shown in FIG. 5. A signal-to-noise ratio of 5 was obtained from the porous gold substrate when probed with 1 nM V5, whereas the flat gold probed with peptide concentrations below 10 nM yielded no significant signal. An equivalent signal improvement was obtained for MS/MS spectra of bound V5 peptide. Meaningful sequence data could be obtained from the MS/MS spectra from the spots on the porous gold probed with V5 concentrations as low as 10 nM, whereas 100 nM V5 was necessary to derive spectra useful for de novo sequencing when the experiment was done with the flat gold (FIG. 12).

### Example 3

Exposure of the Patterned Slides to Potentially Fouling Solutions. In addition to increasing the amount of protein that could be immobilized at the surface, the use of porous gold also resulted in superhydrophobicity in the background regions functionalized with the methyl-terminated SAMs. When the patterned porous gold surfaces are immersed in water and viewed from the side, the trapped layer of air over the superhydrophobic regions appears as a silver color (FIG. 3B2). The printed pattern can be visualized since the hydrophilic spots are wetted and thus do not have a layer of trapped air above them. Patterns generated on flat gold or surfaces with thinner porous gold layers did not display this behavior; therefore, the hydrophobic SAM as well as sufficient surface roughness were both required to achieve underwater superhydrophobicity.

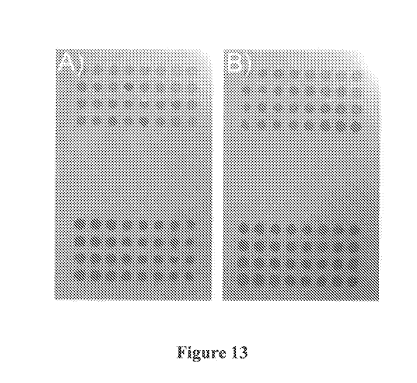

Trapped air seemed to inhibit nonspecific adsorption in the superhydrophobic regions. When hydrophobic/hydrophilic patterns were generated on flat gold surfaces, the pattern was apparent when the slides were immersed in water, similar to the patterned porous gold surfaces. However, when the patterned fiat gold surfaces were briefly immersed in a 1 mg/ml BSA solution, the pattern was irreversibly ruined. That is, even solutions of pure water coated the entire surface and were no longer confined to the hydrophilic spots. In contrast, patterned porous gold slides could be left in a 1 mg/ml BSA overnight with no significant change in the pattern or spot size (FIG. 13). Patterned porous gold surfaces could even be immersed in bovine platelet-poor plasma without ruining the pattern (data not shown). Furthermore, platelet-poor plasma droplets manually added to patterned porous gold surfaces were effectively pinned in the hydrophilic regions without apparent droplet spreading, which could occur if there was nonspecific adsorption to the surrounding hydrophobic surface (data not shown). After repeated or prolonged immersion of these surfaces into platelet-poor plasma, a thin layer of liquid was visible over the hydrophobic regions. However, if the surface was rinsed and dried, the hydrophobic/hydrophilic pattern was restored.

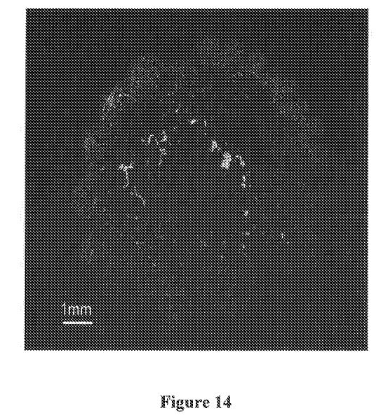

The extent of matrix solution spreading on hydrophilic, glass-based surfaces makes it difficult to obtain MALDI-TOF spectra for individual spots since matrix solution dissociates bound species from immobilized proteins in each spot. Therefore, if the matrix solution spreads over several different spots, the species bound to those spots will be mixed and the spatial information defining their immobilized binding partner is lost. Matrix solution spotted onto a glass slide spread to a diameter of ˜9 mm (FIG. 14). In previous reports, matrix has been allowed to encompass several duplicate spots (Finnskog et al., 3 J. PROTEOME RES. 988-994 (2004)), the entire surface has been uniformly coated with a mixture of antibodies (Patrie et al., 79 ANAL. CHEM. 5878-5887 (2007)), matrix solution has been confined by three-dimensional (3D) polymer structures engineered with photolithography (Gavin et al., 39 BIOTECHNIQUES 99-107 (200.5)), or matrix has been carefully applied as a fine aerosol mist (Nedelkov et al., 79 ANAL. CHEM. 5987-5990 (2007)). In the present invention, matrix solution was effectively contained by the hydrophilic spots of the patterned porous gold (data not shown), maintaining the integrity of individual array elements. Matrix may also be applied using other methods including aerosol or ink-jet based deposition. See, e.g., Schwartz et al., 38 J. MASS SPECTROM. 699-708 (2003); Aerni et al., 78 ANAL. CHEM. 827-834 (2006); and Baluya et al., 79 ANAL. CHEM. 6862-6867 (2007). It is expected that the hydrophobic/hydrophilic pattern will prevent cross-contamination between spots and serve to focus deposited matrix when these methods are employed.

### Example 4

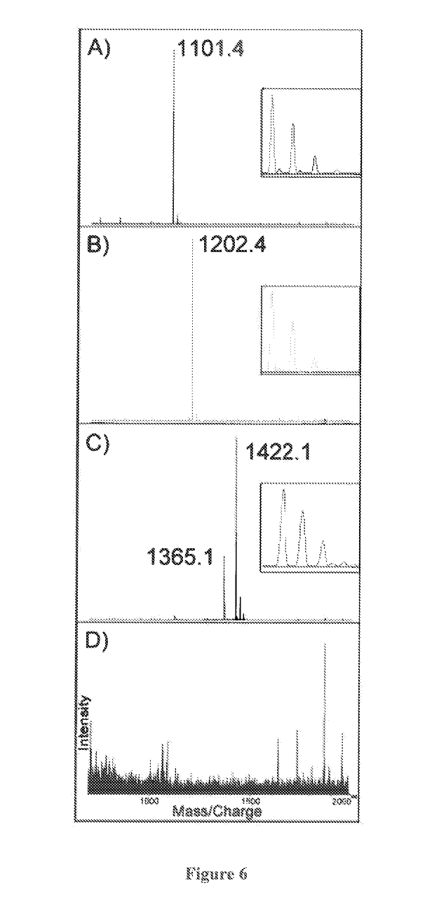

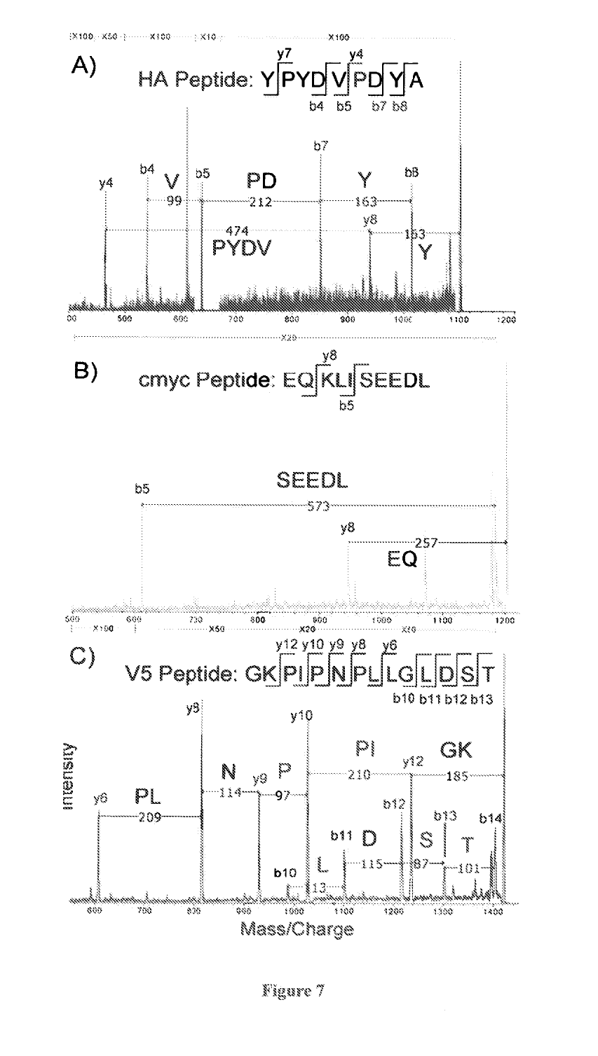

MALDI-TOF Spectra of Peptides Bound to Arrays Exposed to Spiked Plasma. FIG. 6 shows representative reflectron MALDI-TOF spectra from antibody-functionalized spots after exposure to spiked plasma, rinsing, and addition of matrix solution. In this experiment, the slide was patterned by inkjet printing (Shimadzu CHIP) and droplets of the spiked plasma were manually added to the surface. In the spectra obtained for each spot, the m/z of the base peak correlates with the [M+H]⁺ ion for the peptide antigen corresponding with the antibody immobilized at that spot. The hound peptides were also de novo sequenced using the MS/MS spectra (FIG. 7). No nonspecific binding of the peptides was observed in the control IgG spectra, and the intensity of the peaks observed were 2 orders of magnitude lower than the intensity of the peaks for the captured peptides.

The data also serendipitously emphasizes an advantage of using mass spectrometry for detection of antibody arrays. The peak at m/z 1365 in FIG. 6 corresponds to a degradation product of the V5 peptide, the loss of the N-terminus glycine residue. This truncated V5 peptide was also captured by the immobilized anti-V5 antibody and would be recognized as intact V5 peptide by a fluorescence or surface plasmon resonance detection scheme. Whereas antibody specificity can be difficult to determine using other detection methods, the specificity of the immobilized antibodies was readily apparent with mass spectrometry. Moreover, one of ordinary skill in the art can utilize the present invention to analyze other protein interactions that are not as well-defined or specific as antibody-antigen binding and the ability to detect several different species bound to the same immobilize protein.

The spectra shown in FIGS. 6 and 7 were obtained from the largest spot sizes, approximately 1500 μm in diameter, patterned using the Shimadzu CHIP inkjet printer. For all patterns and slides studied, the anti-V5 spots yielded the highest peak intensity, the anti-HA spots yielded an intermediate intensity, and the anti-cmyc spots had the lowest peak intensities. Whether this is due to differences in ionization efficiency between the peptides, differences in affinity between the antibodies, or a convolution of these two is unknown. As the spot sizes decreased, adjustments had to be made to obtain spectra for each spot. For the large spot sizes, high-quality spectra were obtained for each bound peptide in reflectron mode. For intermediate spots sizes, approximately 900 μm in diameter, high-quality spectra were obtained for each bound peptide in linear mode. However, in the less sensitive reflectron mode, only the V5 and HA peptides were detected. For the smallest spot sizes, approximately 700 μm in diameter, only the V5 peptide was detected, and only in linear mode. Increased smoothing and baseline subtraction of the spectra enhances the detection of the bound peptides, but at the sacrifice of isotopic resolution. As would be expected, the effectiveness of mass spectrometry detection of arrays decreases with decreasing spot size.

One of ordinary skill in the art can use the present invention to further improve the high resolution detection and MS/MS analyses of smaller spots. In one embodiment, the rinsing procedure may be optimized to maximize the signal obtained from spots on the array. Indeed, hound peptide may be dissociated from immobilized antibodies if the substrate slides are vigorously rinsed with pure water prior to the addition of matrix. Residual salts from the plasma may suppress the MS signal results in a situation where too much rinsing may dissociate bound peptides and decrease the signal, whereas too little rinsing results in suppression which may also decrease the MS signal. In another embodiment, one of ordinary skill in the art may use ammonium salts in the rinsing procedure. Ammonium buffers are more likely to sustain non-covalent biological interactions while also inhibiting suppression by residual sodium and potassium. See Kiernan et al., 537 FEBS LETT. 166-170 (2003).

### Example 5

MALDI-TOF Imaging of Slides after Peptide Capture. Image data in a format similar to traditional protein array data was generated by dividing the slides into 200 μm² pixels and compiling the spectra collected for each pixel into images. MALDI-TOF images were generated for the slide discussed in the previous example, which was patterned with an inkjet printer and had plasma manually added to the surface as well as for an experiment where the slide was patterned using a pin printer and later exposed to plasma by brief immersion.

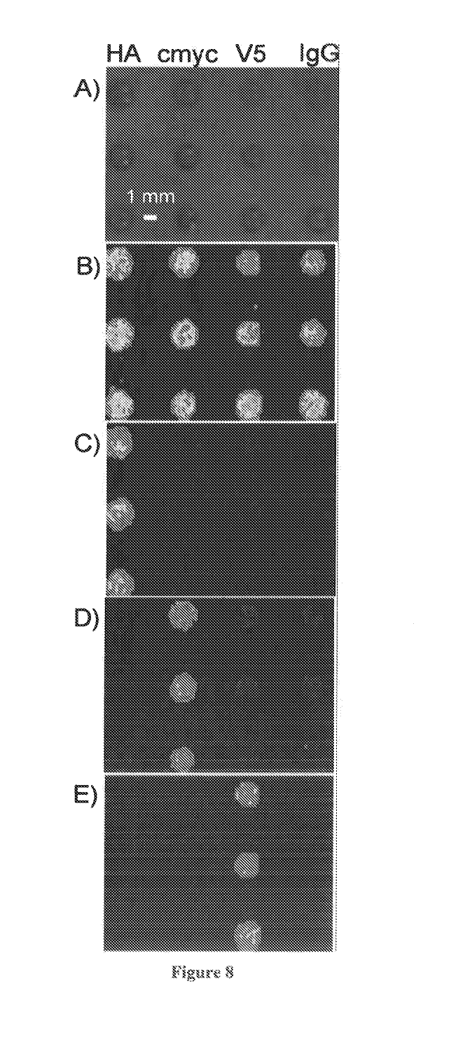

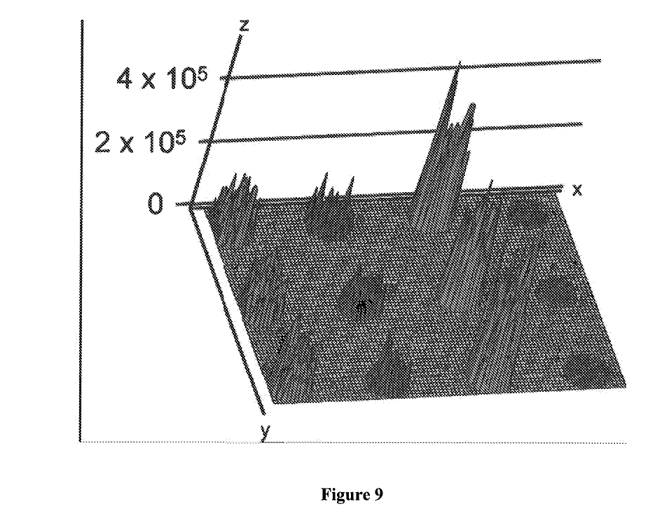

The image of the signal intensity at m/z 378, a peak routinely observed when CHCA matrix is used, displays the effectiveness of the inkjet-printed hydrophobic/hydrophilic pattern in constraining the matrix solution to the hydrophilic spots (FIG. 8B). Images C-E in FIG. 8 illustrate the specific capture of the appropriate peptides by the immobilized antibodies. The hydrophobic areas retained no matrix resulting in an intensity of zero for m/z ranges, hydrophobic areas retained no matrix resulting in an intensity of zero for all m/z ranges, displayed as a black background. Because they contain matrix, there is some chemical noise across the entire m/z range of the mass spectra in the hydrophilic spots. In FIG. 8, the images are normalized to the highest intensity for the m/z range selected and the chemical noise background can be seen as dim violet spots, particularly in the spots not corresponding to the peptide of interest. The signal-to-noise ratios can be visualized as the contrast and intensity between the violet chemical noise in the spots which do not correspond to the peptide of interest and the multicolored spots corresponding to the peptide of interest. The contrast between the V5 spots and the chemical noise spots is so high in the V5 image (FIG. 8E) that the violet chemical noise spots are indistinguishable from the black background, whereas the lower signal-to-noise ratio in the cmyc image makes the violet spots visible (FIG. 8D). The HA image had an intermediate signal-to-noise ratio. FIG. 9 demonstrates an alternative method for viewing the MALDI-TOF image, where the three m/z regions, corresponding to the molecular ion for each of the three peptides, are overlaid against a yellow background. The z-axis is fixed, and the relative intensities of the signals for the HA, cmyc, and V5 peptides are apparent. The mixed colors and low intensity of the IgG control spots demonstrate that the chemical noise from each overlaid m/z region resulted in the small signal visible in the image.

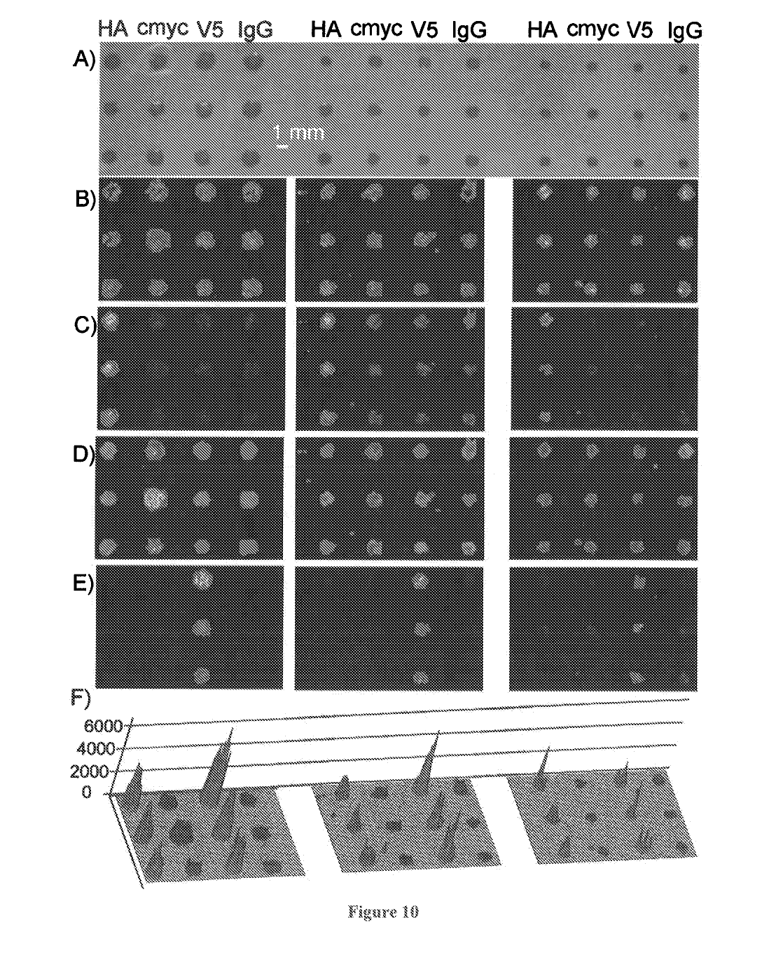

FIG. 10 shows MALDI-TOF images generated from a slide in which the surface was first patterned using a pin printer (rather than an inkjet printer) and then briefly immersed in spiked plasma instead of droplets being manually added. This slide consisted of three arrays with decreasing spot diameters of approximately 1500, 1100, and 850 μm, respectively. The signal-to-noise ratios for preliminary spectra taken before the slide was imaged were lower than for the previously discussed slide, where spiked plasma droplets were manually added (data not shown). The increased amount of chemical noise and salt adducts observed in the spectra from the immersed slide suggest an increased amount of residual salt after rinsing. To compensate for the lower signal-to-noise, the spectrum for each pixel in the image was acquired in linear mode with extensive smoothing and baseline subtraction. Therefore, isotopic resolution and the potential for MS/MS were lost. In the images generated under these conditions, the spots correlating to the HA and V5 peptides are apparent at each spot size (FIG. 10, parts C, E, and F). As in the previous experiment, the signal for the cmyc peptide is comparably lower (FIG. 10, parts D and F). For the smallest spot size, the cmyc signal is difficult to discern from the background. Although smoothing, baseline subtraction, and linear mode were required to enhance the signal in these plasma “dipping” experiments, this approach is more convenient and more amenable to high-throughput analyses.

### Example 6

Drug Screening Assay. An array of the present invention is prepared in which various kinases are attached to the hydrophilic carboxy-terminated SAMs spotted on the array. The array is contacted or probed with numerous peptide inhibitors simultaneously. MS detection and analysis of the array allows one skilled in the art to determine which inhibitors have bound at which kinases and whether multiple peptides bound at the same kinase.

### Example 7

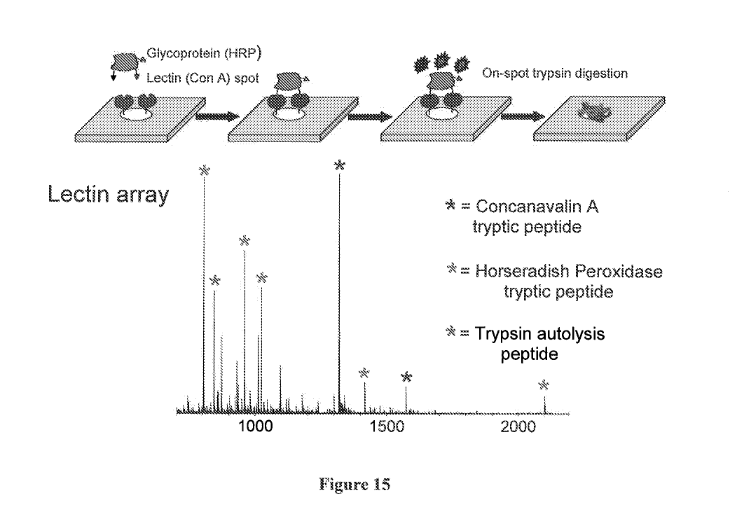

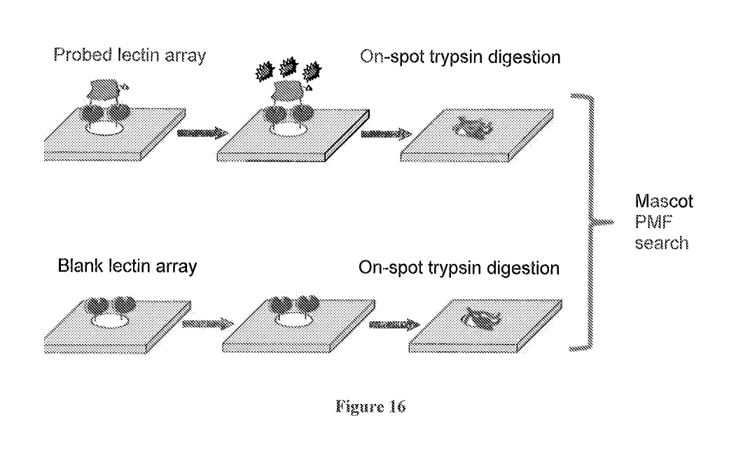

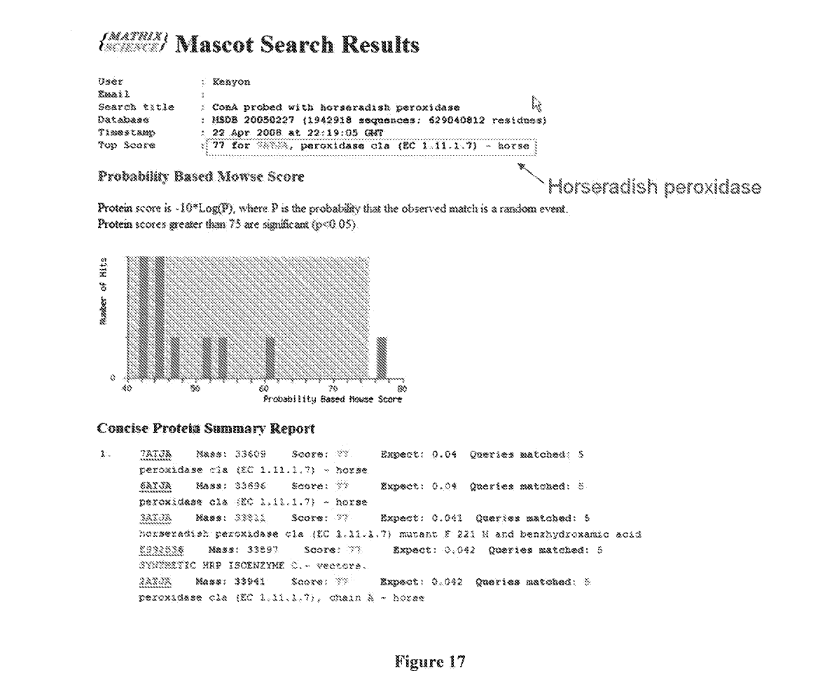

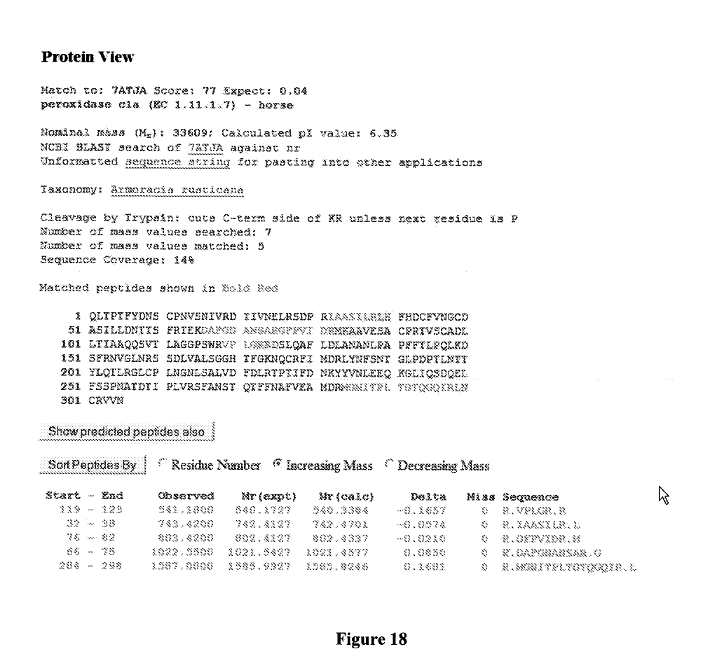

Isolation and Identification of Glycosylation Site in Proteins using MALDI-TOF analysis of Lectin Arrays Probed with Glycoproteins. As shown in FIGS. 14 and 15, an array of the present invention is prepared using the lectin Concanavalin A (Con A). The lectin array is contacted with the highly glycosylated protein, Horseradish Peroxidase (HRP). The array is rinsed, and the HRP bound to the Con A array are subjected to in situ digestion with trypsin. MS analysis of the digested peptides along with the use of other known analytical tools and methods including, but not limited to, a search of MASCOT (available at http://www.matrixscience.com/home.html) provide information about the peptides bound to the array. See FIGS. 14-18.

In an alternative embodiment, an array of the present invention is prepared using various lectins with affinities to different carbohydrates. By digesting glycosylated proteins with trypsin and exposing the trypsinized peptides to a lectin array, only the glycosylated regions of the peptides will bind to the array. Because the array contains various lectins with affinities to different carbohydrates, where each peptide binds will provide information about the identity of the carbohydrate chain on the peptide. Data from MS-MS spectra performed directly on the bound peptide will provide further information about the mass of the attached carbohydrate as well as which amino acid it is bound to the peptide.

### Example 8

Preparation and Use of Kits. Proteins with available thiol groups are dissolved in aqueous solutions containing surfactants to simultaneously immobilize the proteins and generate the hydrophilic spots of the pattern. The superhydrophohic regions are then generated by immersing the array into an aqueous solution of hydrophobic thiol, using surfactants to maintain stability. This method thus allows a one-step printing procedure and facilitates the use of the present invention in a kit format. Researchers already printing arrays on currently available functionalized glass slides could easily incorporate the present invention into the workflow by using such one-step patterning/immobilization kits.

1. A method for characterizing a solution comprising one or more proteins comprising:
a. contacting said solution comprising one or more proteins with a substrate, wherein said substrate comprises (i) a layer of porous gold formed on said substrate; (ii) one or more capture agents attached to at least one hydrophilic material formed on said porous gold; and (ii) at least one hydrophobic material formed on said porous gold;
b. rinsing said substrate; and
c. analyzing said substrate with mass spectrometry.

2. The method of claim 1, wherein said mass spectrometry is matrix-assisted laser desportion/ionization-time of flight mass spectrometry (MALDI-TOF MS).

3. The method of claim 1, wherein said mass spectrometry is tandem mass spectrometry.

4. The method of claim 1, wherein said one or more capture agents is a protein.

5. The method of claim 1, wherein said at least one hydrophilic material comprises a self-assembled monolayer (SAM).

6. The method of claim 1, wherein said at least one hydrophobic material comprises a SAM.

7. The method of claim 5, wherein said SAM comprises a carboxy-terminated SAM.

8. The method of claim 6, wherein said SAM comprises a methyl-terminated SAM.

9. The method of claim 1, further comprising optionally applying a matrix to said substrate prior to said analyzing step.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A substrate comprising:
a. a layer of porous gold formed on said substrate;
b. at least one hydrophilic material formed on a portion of said porous gold;
c. at least one hydrophobic material formed on a portion of said porous gold; and
d. one or more capture agents attached to said at least one hydrophilic material.

32. The substrate of claim 31, wherein said at least one hydrophilic material comprises a SAM.

33. The substrate of claim 31, wherein said at least one hydrophobic material comprises a SAM.

34. The substrate of claim 32, wherein said SAM comprises a carboxy-terminated SAM.

35. The substrate of claim 33, wherein said SAM comprises a methyl-terminated SAM.

36. The substrate of claim 31, wherein said one or more capture agents is a protein.

37. (canceled)

38. (canceled)

39. (canceled)

40. (canceled)

41. (canceled)

42. (canceled)

43. A method for preparing a substrate comprising:
a. treating said substrate with a gold salt solution;
b. applying a negative potential to said substrate treated with said gold salt solution sufficient to cause a layer of porous gold to be deposited on said substrate;
c. forming at least one hydrophilic SAM on a portion of said porous gold; and
d. forming at least one hydrophobic SAM on a portion of said porous gold.

44. The method of claim 43, wherein said at least one hydrophilic SAM comprises a carboxy-terminated SAM.

45. The method of claim 43, wherein said at least one hydrophobic SAM comprises a methyl-terminated SAM.

46. The method of claim 43, further comprising attaching one or more proteins to said at least one hydrophilic SAM formed one a portion of said porous gold.

47. A substrate produced by the method of claim 43.

48. A kit comprising:
a. a first solution comprising at least one hydrophilic SAM to be formed on a portion of porous gold formed on a substrate; and
b. a second solution comprising at least one hydrophobic SAM to be formed on a portion of porous gold formed on a substrate.

49. The kit of claim 48, further comprising one or more substrates on which porous gold is formed.

50. The kit of claim 48, further comprising one or more substrates coated with gold.

51. The kit of claim 48, further comprising a third solution comprising one or more proteins to be attached to said at least one hydrophilic SAM.
